(19) United States
(12) Patent Application Publication
(10) Pub. No.: US 2009/0081504 A1
(43) Pub. Date: Mar. 26, 2009

(54) FUEL CELL

(75) Inventor: Yuusuke SATO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/207,776

(22) Filed: Sep. 10, 2008

(30) Foreign Application Priority Data
Sep. 25, 2007 (JP) 2007-247745

(51) Int. Cl. H01M 8/04

(52) U.S. Cl. 429/25

(57) ABSTRACT

A fuel cell includes: a membrane electrode assembly containing an anode and a cathode which are disposed opposite to one another via an electrolytic membrane; a fuel tank for reserving a fuel to be supplied to the anode of the membrane electrode assembly; a fuel supplying path for connecting the anode and the fuel tank; and a pressurized fuel supplier which is disposed at the fuel supplying path and configured so as to supply the fuel to the anode from the fuel tank by pressurizing the fuel.

### CROSS-REFERENCE TO RELATED APPLICATIONS

This application is based upon and claims the benefit of priority from the prior Japanese Patent Application No. 2007-247745, filed on Sep. 25, 2007; the entire contents of which are incorporated herein by reference.

### BACKGROUND OF THE INVENTION

1. Field of the Invention

The present invention relates to a fuel cell suitable for a direct fuel cell.

2. Description of the Related Art

In a solid polymer fuel cell (PEM) using hydrogen as fuel or a direct methanol fuel cell (DMFC), a plurality of cells are stacked one another. Each cell is configured such that a membrane electrode assembly (MEA) is sandwiched by an anode channel plate and a cathode channel plate. In the membrane electrode assembly, an anode catalytic layer and an anode gas diffusion layer are formed at the anode side of the solid polymer proton conduction membrane and a cathode catalytic layer and a cathode gas diffusion layer are formed at the cathode of the solid polymer proton conduction membrane. In the direct methanol fuel cell, a mixed solution of water and methanol is supplied to the anode and an air is supplied to the cathode.

In the anode of the direct methanol fuel cell, the reaction is caused as follow.

CH₃OH+H₂O→CO₂+6H⁺+6e⁻ (1)

As apparent from equation (1), CO₂ is generated in the anode. In the cathode of the direct methanol fuel cell, the reaction is caused as follows.

3/2O₂+6H⁺+6e⁻→3H₂O (2)

As apparent from equation (2), H₂O is generated in the cathode.

The mixed solution made of CO₂, H₂O and methanol not reacted in the anode is converted into a gas/liquid phase flow and then, discharged from the anode. The gas/liquid phase flow, discharged from the anode, is supplied into a gas/liquid separator disposed at the flow path in the side of the outlet of the anode, and then, separated into the corresponding gas and liquid. The separated liquid is circulated to a mixing tank and the like via a recovering path, and the separated gas is discharged to air (refer to Reference 1).
[Reference 1] USP6,924,055

In the anode of the fuel cell using hydrogen as fuel, the reaction is caused as follows.

H₂→2H⁺+2e⁻ (3)

In the cases that the mixed solution of water and methanol is supplied to the anode in the direct methanol fuel cell and the hydrogen is supplied to the anode in the fuel cell using hydrogen as fuel, a pump for supplying the fuel such as the mixed solution and the hydrogen is required. In the use of the pump, the pressure of the fuel to be discharged from the pump is likely to be fluctuated so that it become difficult to supply the fuel to anode stably and thus, the performance of the electric power generation at the fuel cell can not be stabilized.

### BRIEF SUMMARY OF THE INVENTION

It is an object of the present invention to provide a fuel cell which can supply a fuel to the anode thereof stably so that the performance of the electric power generation thereof can be stabilized.

In order to achieve the above object, an aspect of the present invention relates to a fuel cell, including: a membrane electrode assembly containing an anode and a cathode which are disposed opposite to one another via an electrolytic membrane; a fuel tank for reserving a fuel to be supplied to the anode of the membrane electrode assembly; a fuel supplying path for connecting the anode and the fuel tank; and a pressurized fuel supplier which is disposed at the fuel supplying path and configured so as to supply the fuel to the anode from the fuel tank by pressurizing the fuel.

According to the aspects can be provided a fuel cell which can supply a fuel to the anode thereof stably so that the performance of the electric power generation thereof can be stabilized.

### BRIEF DESCRIPTION OF THE SEVERAL VIEWS OF THE DRAWINGS

FIG. 1 is a cross sectional view schematically showing the structure of a fuel cell according to an embodiment.

FIG. 2 is a cross sectional view schematically showing the structure of a fuel cell according to another embodiment.

FIG. 3 is a cross sectional view schematically showing the structure of a fuel cell according to still another embodiment.

FIG. 4 is a cross sectional view schematically showing the structure of a fuel cell according to a further embodiment.

### DETAILED DESCRIPTION OF THE INVENTION

Hereinafter, the present invention will be described in detail with reference to the drawings.

### First Embodiment

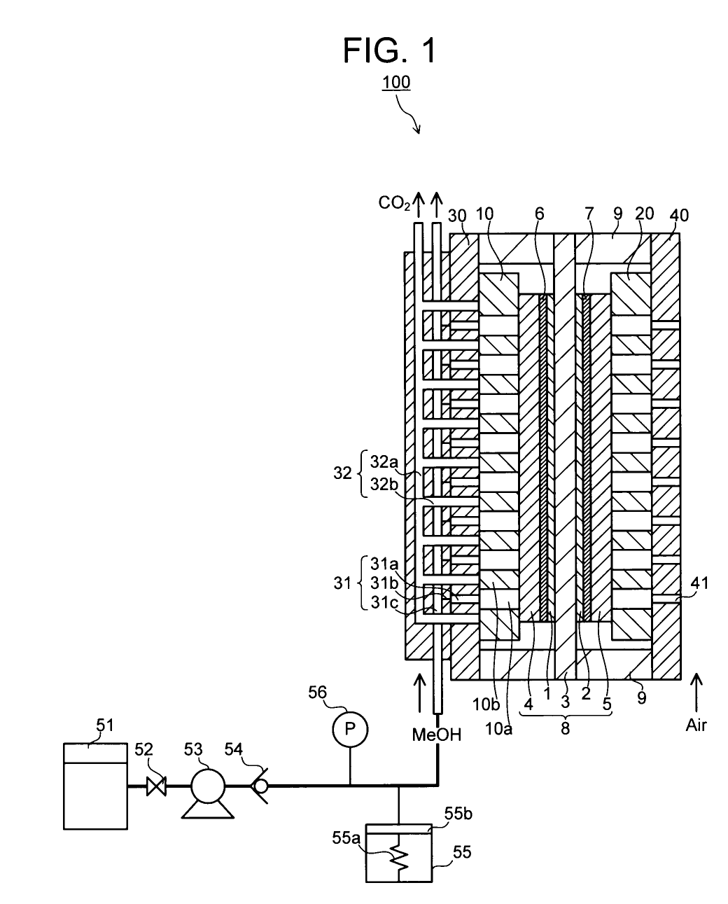

FIG. 1 is a cross sectional view schematically showing the structure of a fuel cell according to a first embodiment. In FIG. 1, the fuel cell 100 includes a membrane electrode assembly (MEA) 8 containing an electrolyte membrane 3, an anode (anode catalytic layer 1 and an anode gas diffusion layer 4) and a cathode (cathode catalytic layer 2 and a cathode gas diffusion layer 5) which are opposite to one another via the electrolyte membrane 3, a hydrophobic porous body 10, an anode channel body 30 adjacent to the hydrophobic porous structure 10, and a cathode channel body 40 which is disposed opposite to the anode channel body 30 via the membrane electrode assembly 8.

The membrane electrode assembly 8 includes the electrolytic membrane 3 made of proton conductive solid polymer membrane, the anode catalytic layer 1 and the cathode catalytic layer 2 which are formed by applying catalytic layers on the main surface of the electrolytic membrane 3, the anode diffusion layer 4 and the cathode diffusion layer 5 which are formed on the outer surfaces of the anode catalytic layer 1 and the cathode catalytic layer 2, respectively. The membrane electrode assembly 8 is sealed by the anode channel body 30 and the cathode channel body 40 with gaskets 9.

The membrane electrode assembly 8 includes the electrolytic film 3 made of proton conductive solid polymer film or the like, the anode catalytic layer 1 and the cathode catalytic layer 2 which are formed by applying the catalytic pastes on the main surface of the electrolytic film 3, respectively, and the anode gas diffusion layer 4 and the cathode gas diffusion layer which are formed on the outer surfaces of the anode catalytic layer 1 and the cathode catalytic layer 2, respectively.

The electrolytic membrane 3 may be made of a copolymer of tetrafluoroethylene and perfluorovinylether sulfonic acid. As the copolymer, Nafion (trade name) made by US DuPont Corp. Ltd may be exemplified. The anode catalytic layer 1 may be made of PtRu and the cathode catalytic layer 2 may contain Pt or the like. The anode-gas diffusion layer 4 and the cathode gas diffusion layer may contain carbon paper or the like.

Not shown in FIG. 1, an anode microporous layer 6 with a thickness of several ten μm and made of carbon may be provided between the anode catalytic layer 1 and the anode gas diffusion layer 4. The anode microporous layer is water-repellent finished and the diameter of each pore in the anode microporous layer is set in the order of submicrometer. Alternatively, a cathode microporous layer 7 with a thickness of several ten μm and made of carbon may be provided between the cathode catalytic layer 2 and the cathode gas diffusion layer 5. In this case, the diameter of each pore in the cathode microporous layer is set in the order of submicrometer.

A plurality of through-holes 10a are formed in the hydrophobic porous body 10 therethrough so that one opening of each through-hole 10a is opened to the anode gas diffusion layer 4 and the other opening of each through-hole 10a is opened to the anode channel body 30. Since the through-holes 10a function as respective fuel supplying paths for the anode, the through-holes 10a function as respective lyophilic through-holes. Then, lyophilic porous material may be set into the through-holes 10a. The hydrophobic porous body 10 may be made of sheet-shaped hydrophobic carbon paper or hydrophobic sintered metal body. The through-holes 10a may be made as fine pores so that the diameter of each through-hole 10a is set within a range of several tm to several mm. The diameter of each through-hole 10a can be changed in accordance with the channel width of the anode channel body 30.

The anode channel body 30 includes a fuel supplying paths 31 and a gas collecting paths 32. Each fuel supplying path 31 contains a first path 31a communicated with the through-hole 10a of the hydrophobic porous body 10, a second path 31b with large fluid resistance and positioned in the upstream side from the first path 31a, and a third path 31c positioned in the upstream side from the second path 31b.

Fuel is partially supplied to the anode gas diffusion layer 4, that is, the anode from the first path 31a through the third path 31c and the second path 31b because the first path 31a is communicated with the second path 31b. Since the diameter of the second path 31b is set smaller than the diameters of the first path 31a and the third path 31c so that the fluid resistance (hereinafter, defined by the resistance between the fluid and the flow path for the fluid to be passed) of the second path 31b is set larger than the fluid resistances of the first path 31a and the third path 31c, the fuel concentration in the first path 31a can be set lower than the fuel concentration in the third path 31c, that is, in the side of the fuel tank. Therefore, the fuel concentration to be supplied to the anode can be easily set to a predetermined fuel concentration so that the electric power generation at the fuel cell 100 can be conducted effectively and efficiently. Moreover, since the back diffusion of moisture generated at the cathode from the first path 31a to the third path 31c can be prevented, the fuel concentration in the third path 31c, that is, in the side of the fuel tank can not be diluted by the moisture so that the intended fuel can be supplied to the anode under a prescribed fuel condition and thus, the performance of the electric power generation can be stabilized.

The third path 31c may be formed as a serpentine path which is configured such that the fuel is flowed in one or plural serpentine-shaped paths from the upstream thereof to the downstream thereof. One end of the third path 31c is connected with the fuel tank 51. With the third path 31c, a valve 52, a pump 53, a check valve 54, a pressure gauge 56 and a pressurized fuel supplier 55 are subsequently provided between the membrane electrode assembly 8 and the fuel tank 51.

The pressurized fuel supplier 55 is configured such that the fuel supplied from the fuel tank 51 can be appropriately reserved in the top portion 55b thereof and the top portion 55b is supported by the pressurizing mechanism 55a provided under the top portion 55b. The pressurizing mechanism 55a can be formed as a piston with a spring configured so as to push up and pressurize the top portion 55b by the pushing force of the spring. Alternatively, the pressurized mechanism 55a may be made of elastic member such as bellows and rubber member.

Then, a pressure detector such as a pressure gauge or a fuel volume detector such as an optical position sensor may be provided in the top portion 55b with the fuel therein of the pressurized fuel supplier 55. Therefore, the reserving degree of the fuel in the top portion 55b can detected and monitored.

The gas collecting path 32 includes a serpentine path 32a which is configured such that gas is flowed in one or plural serpentine-shaped paths from the upstream thereof to the downstream thereof and a collecting path 32b which is diverged from the serpentine path 32 toward the anode gas diffusion layer 4 and collects the gas such as CO₂ from the anode gas diffusion layer 4. The one end of the collecting path 32b is opened to a portion of the hydrophobic porous body 10 without the through-holes 10a (e.g., the area 10b shown in FIG. 1).

In this embodiment relating to FIG. 1, the structures and arrangements of the fuel supplying path 31 and the gas collecting path 32 are exemplified so that any structure and arrangement thereof can be naturally employed. The through-holes 10a may not be formed at the hydrophobic porous body 10. In the use of methanol aqueous solution as the fuel, for example, the methanol aqueous solution can be supplied as a fluid and a mixture of methanol and moisture to the anode catalytic layer 1 through the hydrophobic porous body 10. Liquid alcohol, hydrocarbon, ether or the like may be employed as the fuel instead of methanol.

A plurality of through-holes 41 are formed at the cathode channel body 40 so as to supply air to the cathode catalytic layer 2. A porous body 20 with the moisturizing function for preventing the drying of the cathode catalytic layer 2 may be disposed between the cathode gas diffusion layer 5 and the cathode channel body 40. In this embodiment, the air can be supplied by means of air breathing (natural aspiration), but may be by means of pump.

According to the fuel cell 100 shown in FIG. 1, the fuel is taken into the through-holes 10a as lyophilic holes from the fuel supplying path 31, not into the hydrophobic porous body 10 due to the hydrophoby of the porous body 10. On the other hand, CO₂ generated at the anode through the anode reaction and carried to the anode gas diffusion layer 4 is dominantly passed through the hydrophobic porous body 10 because the CO₂ can be easily passed through the hydrophobic porous body 10 due to the micropores thereof in comparison with that the CO₂ is taken in the through holes 10a so as to form bubbles in the fuel charged in the through-holes 10a when the CO₂ reaches the interface between the anode gas diffusion layer 4 and the hydrophobic porous body 10.

The CO₂ is collected at the gas collecting path 32 opened to the hydrophobic porous body 10 after the CO₂ is passed through the hydrophobic porous body 10. Therefore, the CO₂ can not be flowed in the fuel supplying path 31. As a result, the interfusion of the gas such as CO₂ in the fuel at the outlet of the fuel supplying path 31 can be prevented so that the flow velocity of the fuel due to the volume expansion originated from the formation of a gas/liquid phase flow can be reduced and the pressure loss of the fuel at the anode (fuel supplying path 31) can be remarkably reduced so as to prevent the pressure loss of the fuel due to meniscus.

Since the amount of CO₂ passing through the anode gas diffusion layer 4 per unit area thereof is low, the pressure loss of CO₂ when passing through the hydrophobic porous body 10 can be reduced. In the fuel cell 100 in FIG. 1, since the hydrophobic porous body 10 is provided, the fuel not reacted can be easily separated from the CO₂ even though the membrane electrode assembly 8 is inclined.

The supply of the fuel to the anode will be conducted as follows. In the third paths 31c, the fuel is temporarily supplied to the pressurized fuel supplier 55 from the fuel tank 51 via the valve 52 by means of the pump 53, and then, reserved in the top portion 55b of the supplier 55. Then, the fuel reserved in the top portion 55b is pressurized by the pressurizing mechanism 55a positioned under the top portion 55b so that a prescribed amount of the fuel is discharged from the top portion 55b in accordance with the pressure (pushing force) by the pressurizing mechanism 55a. The fuel is supplied to the anode through the third path 31c, the second path 31b and the first path 31a after discharged, and consumed at the electric power generation in the fuel cell 100.

The fuel to be reserved in the top portion 55b of the pressurized fuel supplier 55 is monitored by a pressure detector or volume detector so that a prescribed amount of the fuel can be always reserved in the top portion 55b.

In this embodiment, the supply of the fuel to the anode is conducted by the pushing force of the pressurized fuel supplier 55 while the pressurized fuel supplier 55 is operated under no external power supply like a pump. As a result, the supply of the fuel to the anode can be conducted stably so that the performance of the electric power generation at the fuel cell 100 can be stabilized.

In this embodiment, since the check valve 54 is provided, the pressure of the fuel can be maintained from the discharge through the pressurized fuel supplier 55 to the supply to the anode in the third path 31c even though the pump 53 is stopped. Namely, once the fuel is reserved and maintained in the pressurized fuel supplier 55 from the fuel tank 51, the fuel can be supplied to the anode stably so that the electric power generation at the fuel cell 100 can be stabilized even though the pump 53 is stopped. Moreover, the electric power for supplying the fuel can be saved.

### Second Embodiment

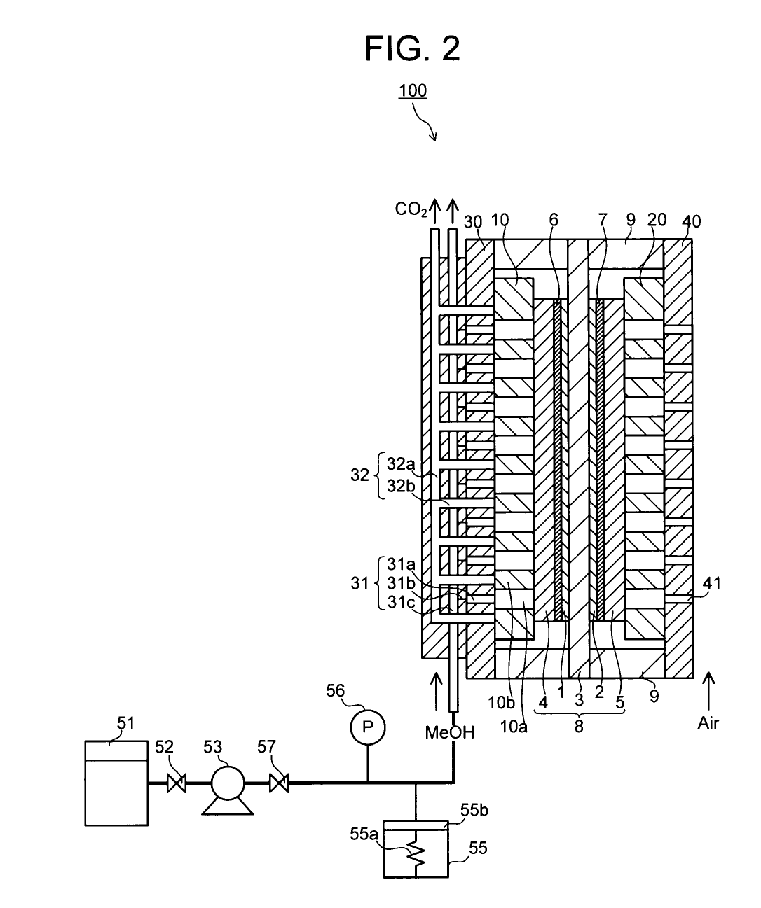

FIG. 2 is a cross sectional view schematically showing the structure of a fuel cell according to a second embodiment. In FIGS. 1 and 2, like or corresponding constituent components are designated by the same reference numerals.

As apparent from FIG. 2, the second embodiment is an embodiment modified from the first embodiment so that the fuel cell in this embodiment is configured similar to the one in the first embodiment except that the check valve 54 in FIG. 1 is substituted with a valve 57. In this embodiment, therefore, explanation is centered on the different structure between the first embodiment and the second embodiment so that explanation for like or corresponding constituent components will be omitted.

In this embodiment, the supply of the fuel to the anode will be conducted in the same manner as the first embodiment. Concretely, in the third paths 31c, the fuel is temporarily supplied to the pressurized fuel supplier 55 from the fuel tank 51 via the valve 52 by means of the pump 53, and then, reserved in the top portion 55b of the supplier 55. Then, the fuel reserved in the top portion 55b is pressurized by the pressurizing mechanism 55a positioned under the top portion 55b so that a prescribed amount of the fuel is discharged from the top portion 55b in accordance with the pressure (pushing force) by the pressurizing mechanism 55a. The fuel is supplied to the anode through the third path 31c, the second path 31b and the first path 31a after discharged, and consumed at the electric power generation in the fuel cell 100.

The fuel to be reserved in the top portion 55b of the pressurized fuel supplier 55 is monitored by the pressure detector or volume detector so that a prescribed amount of the fuel can be always reserved in the top portion 55b.

In this embodiment, the supply of the fuel to the anode is conducted by the pushing force of the pressurized fuel supplier 55 while the pressurized fuel supplier 55 is operated under no external power supply like a pump. As a result, the supply of the fuel to the anode can be conducted stably so that the performance of the electric power generation at the fuel cell 100 can be stabilized.

In this embodiment, although the valve 57 is provided in substation for the check valve 54, the pressure of the fuel can be maintained from the discharge from the pressurized fuel supplier 55 to the supply to the anode in the third path 31c by closing the valve 57 even though the pump 53 is stopped. Namely, once the fuel is reserved and maintained in the pressurized fuel supplier 55 from the fuel tank 51, the fuel can be supplied to the anode stably so that the electric power generation at the fuel cell 100 can be stabilized even though the pump 53 is stopped.

### Third Embodiment

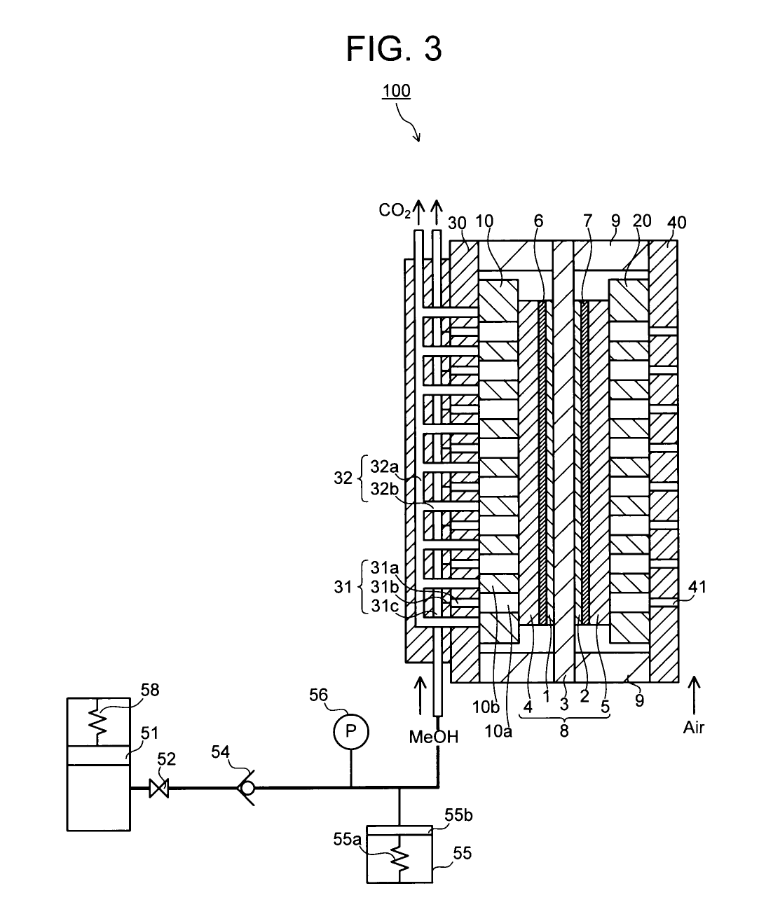

FIG. 3 is a cross sectional view schematically showing the structure of a fuel cell according to a third embodiment. In FIGS. 1 and 3, like or corresponding constituent components are designated by the same reference numerals.

As apparent from FIG. 3, the third embodiment is an embodiment modified from the first embodiment so that the fuel cell in this embodiment is configured similar to the one in the first embodiment except that a pressurizing mechanism 58 is provided in the fuel tank 51. According to the pressurizing mechanism 58, the pressure of the fuel reserved in the fuel tank 51 is set higher than the pressure of the fuel reserved in the pressurized fuel supplier 55. In this embodiment, therefore, explanation is centered on the different structure between the first embodiment and the third embodiment so that explanation for like or corresponding constituent components will be omitted.

In this embodiment, the supply of the fuel to the anode will be conducted in the same manner as the first embodiment. Concretely, in the third paths 31c, the fuel is temporarily and intermittently supplied to the pressurized fuel supplier 55 from the fuel tank 51 via the valve 52 by means of the pump 53, and then, reserved in the top portion 55b of the supplier 55. Then, the fuel reserved in the top portion 55b is pressurized by the pressurizing mechanism 55a positioned under the top portion 55b so that a prescribed amount of the fuel is discharged from the top portion 55b in accordance with the pressure (pushing force) by the pressurizing mechanism 55a. The fuel is supplied to the anode through the third path 31c, the second path 31b and the first path 31a after discharged, and consumed at the electric power generation in the fuel cell 100.

The fuel to be reserved in the top portion 55b of the pressurized fuel supplier 55 is monitored by the pressure detector or volume detector so that a prescribed amount of the fuel can be always reserved in the top portion 55b.

In this embodiment, the supply of the fuel to the anode is conducted by the pushing force of the pressurized fuel supplier 55 while the pressurized fuel supplier 55 is operated under no external power supply like a pump. As a result, the supply of the fuel to the anode can be conducted stably so that the performance of the electric power generation at the fuel cell 100 can be stabilized.

In this embodiment, since the check valve 54 is provided, the pressure of the fuel can be maintained from the discharge from the pressurized fuel supplier 55 to the supply to the anode in the third path 31c even though the pump 53 is stopped. Without the check valve 54, if the valve 52 is closed, the pressure of the fuel in the third path 31c can be maintained to a predetermined value of pressure. As a result, the fuel can be supplied stably to the anode so that the electric power generation at the fuel cell 100 can be stabilized only if the fuel is reserved in the pressurized fuel supplier 55.

The pressurizing mechanism 55 disposed in the fuel tank 51 may be made of the partition wall and the spring connected with the partition wall. Without the pressurizing mechanism 55, if the fuel is pressurized by a pressuring gas or a liquefied gas via the partition wall, the same function/effect as the pressuring mechanism 55 can be obtained.

### Fourth Embodiment

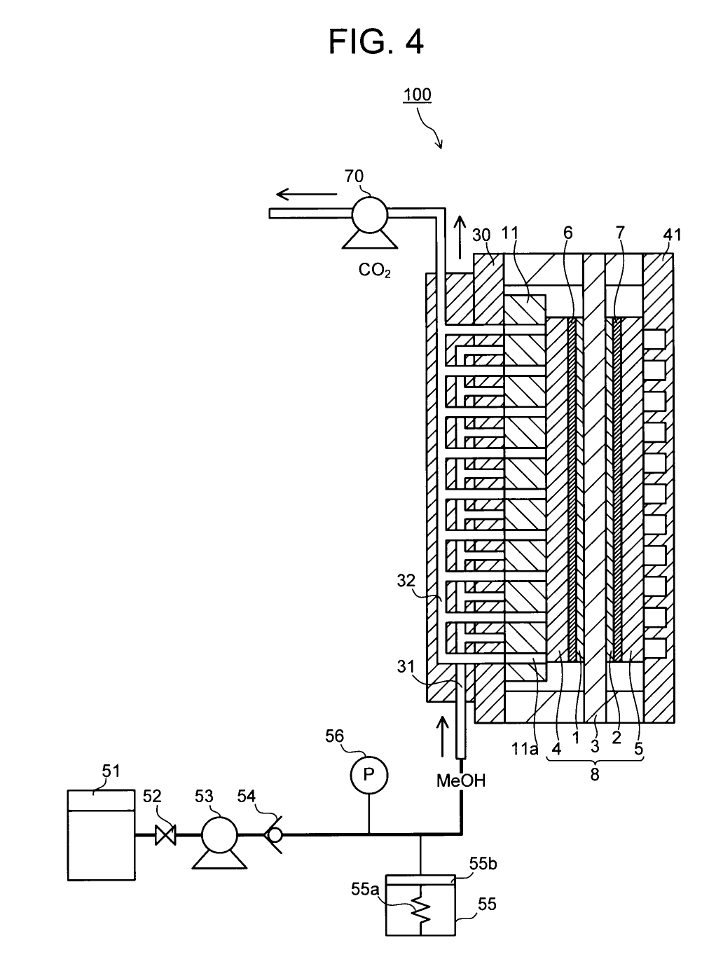

FIG. 4 is a cross sectional view schematically showing the structure of a fuel cell according to a fourth embodiment. In FIGS. 1 and 4, like or corresponding constituent components are designated by the same reference numerals.

As apparent from FIG. 4, the fourth embodiment is an embodiment modified from the first embodiment so that the fuel cell in this embodiment is configured similar to the one in the first embodiment except that a lyophilic porous body 11 is disposed between the anode channel body 30 and the anode gas diffusion layer 4 instead of the hydrophobic porous body 10. In this embodiment, therefore, explanation is centered on the different structure between the first embodiment and the fourth embodiment so that explanation for like or corresponding constituent components will be omitted.

In this embodiment, a plurality of through-holes 11a are formed in the lyophilic porous body 11 therethrough so that one opening of each through-hole 11a is opened to the anode gas diffusion layer 4 and the other opening of each through-hole 11a is opened to the anode channel body 30. The lyophilic porous body 11 may be made of sheet-shaped lyophilic carbon paper of lyophilic carbon fiber or cloth, lyophilic sintered metal body. The through-holes 11a may be made as fine pores so that the diameter of each through-hole 11a is set within a range of several μm to several mm. The diameter of each through-hole 11a can be changed in accordance with the channel width of the anode channel body 30.

In FIG. 4, the one ends of the gas collecting paths 32 of the anode channel body 30 are communicated with the through holes 11a of the lyopholic porous body 11, respectively. The one ends of the fuel supplying paths 31 are opened to a portion of the lyophilic porous body 11 without the through-holes 11a (e.g., the area 11b shown in FIG. 4).

According to the fuel cell 100 shown in FIG. 4, the fuel is taken in and maintained at the lyophilic porous body 11 from the fuel supplying path 31. On the other hand, CO₂ generated at the anode through the anode reaction and carried to the anode gas diffusion layer 4 is dominantly passed through the through-holes 11a because the CO₂ can be easily passed through the through-holes 11a in comparison with that the CO₂ is passed through the lyophilic porous body 11 with the fuel therein when the CO₂ reaches the interface between the anode gas diffusion layer 4 and the lyophilic porous body 11.

The CO₂ is collected at the gas collecting paths 32 by means of a pump 70 communicated with the gas collecting paths 32 after the CO₂ is passed through the through-holes 11a. Therefore, the CO₂ can not be flowed in the fuel supplying path 31. As a result, the interfusion of the gas such as CO₂ in the fuel at the outlet of the fuel supplying path 31 can be prevented so that the flow velocity of the fuel due to the volume expansion originated from the formation of a gas/liquid phase flow can be reduced and the pressure loss of the fuel at the anode (fuel supplying path 31) can be remarkably reduced.

In the fuel cell 100 in FIG. 4, since the lyophilic porous body 11 is provided, the fuel not reacted can be easily separated from the CO₂ even though the membrane electrode assembly 8 is inclined.

In this embodiment, the supply of the fuel to the anode will be conducted in the same manner as the first embodiment so that the same function/effect as the first embodiment relating to the supply of the fuel can be exhibited.

Although the present invention was described in detail with reference to the above examples, this invention is not limited to the above disclosure and every kind of variation and modification may be made without departing from the scope of the present invention.

What is claimed is:

1. A fuel cell, comprising:
a membrane electrode assembly containing an anode and a cathode which are disposed opposite to one another via an electrolytic membrane;
a fuel tank for reserving a fuel to be supplied to said anode of said membrane electrode assembly;
a fuel supplying path for connecting said anode and said fuel tank; and
a pressurized fuel supplier which is disposed at said fuel supplying path and configured so as to supply said fuel to said anode from said fuel tank by pressurizing said fuel.

2. The fuel cell as set forth in claim 1,
wherein said pressurized fuel supplier is configured such that said fuel is partially reserved therein and supplied to said anode by pressuring said fuel reserved therein.

3. The fuel cell as set forth in claim 2,
wherein said pressurized fuel supplier includes a reserving portion and a pressurizing mechanism provided adjacent to said reserving portion.

4. The fuel cell as set forth in claim 3,
wherein said pressurized mechanism includes a piston with a spring.

5. The fuel cell as set forth in claim 3, further comprising a pressure detector and/or a volume detector for detecting and controlling a reserving degree of said fuel in said top reserving portion.

6. The fuel cell as set forth in claim 2,
wherein a pressure of said fuel in said fuel tank is set higher than a pressure of said fuel reserved in said pressurized fuel supplier, and said fuel is intermittently supplied to said pressurized fuel supplier from said fuel tank.

7. The fuel cell as set forth in claim 6, further comprising a pressurizing mechanism in said fuel tank.

8. The fuel cell as set forth in claim 1, further comprising a hydrophobic porous body adjacent to said anode so that a gas generated at said anode is discharged from said hydrophobic porous body.

9. The fuel cell as set forth in claim 8,
wherein said fuel is supplied to said anode from an area except said hydrophobic porous body.

10. The fuel cell as set forth in claim 9,
wherein said area is a lyophilic porous structure formed in said hydrophobic porous body so that said fuel is supplied to said anode from said lyophilic porous structure.

11. The fuel cell as set forth in claim 10,
wherein said lyophilic porous structure includes through-holes formed through said hydrophobic porous body.

12. The fuel cell as set forth in claim 8,
wherein said fuel supplying path includes a first path connected with said hydrophobic porous body, a second path with large fluid resistance and positioned in an upstream side from said first path, and a third path positioned in an upstream side from said second path,
wherein said pressurized fuel supplier is disposed at said third path.

13. The fuel cell as set forth in claim 1, further comprising a lyophilic porous body adjacent to said anode so that said fuel is maintained therein.

14. The fuel cell as set forth in claim 13,
wherein a gas generated at said anode is discharged from an area except said lyophilic porous body.

15. The fuel cell as set forth in claim 14,
wherein said area includes through-holes formed through said lyophilic porous body.

16. The fuel cell as set forth in claim 13,
wherein said fuel supplying path includes a first path connected with said lyophilic porous body, a second path with large fluid resistance and positioned in an upstream side from said first path, and a third path positioned in an upstream side from said second path,
wherein said pressurized fuel supplier is disposed at said third path.
